(19) United States
(12) Patent Application Publication
(10) Pub. No.: US 2020/0261942 A1
(43) Pub. Date: Aug. 20, 2020

(54) AERATED MELTABLE WAX APPLICATION ASSEMBLY AND METHOD OF USING THE SAME

(71) Applicant: Simchem Inc., Chapel Hill, NC (US)

(72) Inventors: Raymond Columbus Simmons, Chapel Hill, NC (US); Benjamin Simmons, Chapel Hill, NC (US)

(21) Appl. No.: 16/278,498

(22) Filed: Feb. 18, 2019

(51) Int. Cl. B05D 7/24; B05C 5/00; B05D 1/30; B01F 3/04; B05C 11/10

(52) U.S. Cl. CPC B05D 7/24; B05C 5/005; B05D 1/305; B01F 2003/04964; B05C 11/1005; B01F 2003/04872; B01F 3/04106

(57) ABSTRACT

An aerated wax application assembly comprises a meltable wax applicator, one or more meltable wax delivery conduits having a first end coupled to the meltable wax inlet of the meltable wax applicator and a second end positioned proximate a meltable wax holding tank, and an air injection system positioned upstream from the meltable wax applicator and configured to inject air into the meltable wax and generate the aerated meltable wax upstream of the inlet of the meltable wax applicator. A method of applying an aerated meltable wax onto an object comprises injecting air into a meltable wax such that it forms an aerated meltable wax, delivering the aerated wax through one or more meltable wax delivery conduits to a meltable wax applicator, and contacting at least one exposed surface of the object with the aerated wax when dispensing the aerated meltable wax from an outlet of the meltable wax applicator.

### BACKGROUND

In various adhesive applications, incorporating air bubbles into a meltable wax may create an aerated wax having a decreased density without significantly decreasing the effectiveness of the wax for a particular intended use. For example, the effectiveness of certain waxes used in the production and or treatment of corrugated board is not significantly decreased by incorporating air bubbles into the wax to form an aerated wax product. Further, for example, certain adhesives may also saturate a corrugated board so as to create a liquid-resistant coating having similar liquid resistivity regardless of whether the adhesive solution does or does not have air bubbles incorporated throughout. Therefore, incorporating air bubbles into a wax to form an aerated wax or wax product may provide a cost savings measure by decreasing the amount of the adhesive needed for a particular application.

Historically, wax-coated corrugated boxes have been utilized to transport cargo that may be particularly likely to expose the box to moisture. Where moisture can compromise the structural integrity of a corrugated box, those skilled in the art typically apply a coat of wax to those boxes likely to carry liquid-bearing cargo, so as to eliminate or at least minimize the box's exposure to moisture, and thus prevent its destruction and/or deterioration. Typically, a wax coating is applied to the above-referenced boxes by simply melting max and using one of the methods known in the art to coat the surfaces of the box likely to interact with moisture with the melted wax. As a non-limiting example, in the shipping industry, such coated boxes are often used to transport produce or other items across the country for weeks at a time. Notably, associated shipping costs are greatly influenced by the total weight of the package (box and contents included) being shipped. Because a portion of the total weight is also attributable to the applied wax, efficiently and effectively applying the same may also provide a reduction in the total weight of box being shipped, thereby reducing costs. To date, no efficient and/or effective ways to reduce the weight of the wax applied—apart from simply applying less wax and losing a desirable degree of the protection provided thereby—have proven successful.

Therefore, where it may be desirable for the density—and thus the weight—of the wax applied to a cargo-carrying box to be reduced, minimized, and/or otherwise optimized, a need exists for methods and assemblies configured to effectively and efficiently reduce weight of wax applied while maintaining the desirable degree of protection conventionally achieved.

### BRIEF SUMMARY

Various embodiments are directed to a method of applying an aerated meltable wax onto an object. The method may comprise: injecting air into a meltable wax such that it forms an aerated meltable wax; delivering the aerated meltable wax through one or more meltable wax delivery conduits and to a meltable wax applicator; and positioning the object relative to the meltable wax applicator such that an at least one exposed surface of the object is fully engaged by at least a portion of the aerated meltable wax dispensing from an outlet of the meltable wax applicator.

In various embodiments, the air is injected into the meltable wax with an air injection system, wherein the air injection system comprises: an air inlet, through which air flows into a first end of one or more air delivery conduits, and one or more air injector outlets coupled to a second end of the one or more air delivery conduits.

In various embodiments, the method may further comprise using one or more meltable wax pumps to drive the meltable wax from a meltable wax holding tank, into and through the one or more meltable wax delivery conduits, and into the meltable wax applicator through the meltable wax inlet of the applicator.

In various embodiments, the method may further comprise using an inline mixer positioned within one or more of the one or more meltable wax delivery conduits and downstream from the air injector system to form a wax-air solution as the meltable wax and air flow through the meltable wax delivery conduit, wherein the inline mixer defines a tortuous fluid travel path configured to mix the meltable wax and the air.

In various embodiments, the method may further comprise using a sensor positioned within one or more of the one or more meltable wax delivery conduits and downstream from the air injector to determine the amount of air present in the meltable wax at a location along the one or more meltable wax delivery conduits.

The air injection system may comprise in various embodiments one or more air pulsing devices, the one or more air pulsing devices being arranged between the air inlet and the one or more air delivery conduits such that the one or more air pulsing devices may selectively pulse air from the air inlet through the one or more air delivery conduits and to the one or more air injector outlets.

Further, the one or more air injector outlets may be positioned upstream from both the first and the second ends of the one or more meltable wax delivery conduits, and may comprise an air nozzle, the air nozzle defining a plurality of entry openings through which air flows such that when the air nozzle is submerged in a meltable wax, the air flowing through the plurality of entry openings creates air bubbles within the meltable wax.

In various embodiments, the one or more air injector outlets may be positioned within the meltable wax holding tank and may be positioned at least substantially proximate the second end of the one or more wax delivery conduits.

In various embodiments, the one or more air injector outlets may be positioned upstream from the meltable wax holding tank.

In various embodiments, the one or more air injector outlets may be positioned upstream from the first end of the one or more meltable wax delivery conduits and downstream from the second end of the one or more fluid delivery conduits, such that the meltable wax may be aerated while flowing through the one or more meltable wax delivery conduits.

Various embodiments are also directed to an air-infused meltable wax application assembly for incorporating air into an adhesive (e.g., wax) to form an aerated meltable wax and applying the aerated meltable wax onto an object. In various embodiments, the assembly comprises: a meltable wax applicator, the meltable wax applicator comprising a meltable wax inlet an a meltable wax outlet; one or more meltable wax delivery conduits coupled on a first end to the meltable wax inlet of the fluid applicator and having a second end positioned at least substantially proximate to a meltable wax holding tank; and an air injection system positioned upstream from the meltable wax applicator.

In various embodiments, the assembly additionally comprises one or more meltable wax pumps configured to drive the meltable wax from the meltable wax holding tank, into and through the one or more meltable wax delivery conduits, and into the meltable wax applicator through the meltable wax inlet of the applicator.

In various embodiments, the assembly may further comprise an inline mixer positioned within one or more of the one or more meltable wax delivery conduits and downstream from the air injector system, wherein the inline mixer defines a tortuous fluid travel path configured to mix the meltable wax and the air to form a wax-air solution as the meltable wax and air flow through the meltable wax delivery conduit.

In various embodiments, the assembly may additionally comprise a sensor positioned within one or more of the one or more meltable wax delivery conduits and downstream from the air injector system, wherein the sensor may determine the amount of air present in the meltable wax at a location along the one or more meltable wax delivery conduits.

In various embodiments the air injection system may comprise an air inlet, through which air flows into one or more air delivery conduits; one or more air injector outlets; and wherein the air inlet is positioned upstream from the air injector outlet, and the one or more air injector outlets are coupled to the air delivery conduit to receive air from the air inlet.

In various embodiments, the air injection system further comprises one or more air pulsing device, the one or more air pulsing devices being arranged between the air inlet and the one or more air delivery conduits such that the one or more air pulsing devices may selectively pulse air from the air inlet through the one or more air delivery conduits and to the one or more air injector outlets.

Further, the one or more air injector outlets may comprise an air nozzle, the air nozzle defining a plurality of entry openings through which air flows such that when the air nozzle is submerged in a meltable wax, the air flowing through the plurality of entry openings may create air bubbles within the meltable wax.

In various embodiments the air injector outlet may be positioned upstream from both the first and the second ends of the meltable wax delivery conduit, while in other embodiments, the air injector outlet may be positioned upstream from the first end of the meltable wax delivery conduit and downstream from the second end of the fluid delivery conduit, such that the meltable wax may be aerated while flowing through the one or more meltable wax delivery conduits.

Further, in various embodiments the one or more air injector outlets are positioned within the meltable wax holding tank positioned at least substantially proximate the second end of the one or more wax delivery conduits. The one or more air injector outlets may be positioned upstream from the meltable wax holding tank.

In various embodiments, there is also provided a computer implemented method of applying an aerated meltable wax onto an object, the method comprising: injecting air into a meltable wax such that it forms an aerated meltable wax; delivering the aerated meltable wax through one or more meltable wax delivery conduits to a meltable wax applicator; positioning the object relative to the meltable wax applicator such that an at least one exposed surface of the object is fully engaged by at least a portion of the aerated meltable wax dispensing from an outlet of the meltable wax applicator.

In various embodiments, there is also provided a computer program product comprising at least one non-transitory computer-readable storage medium having computer-readable program code portions embodied therein, the computer-readable program code portions comprising one or more executable portions. The one or more executable portions are configured for at least: controlling an injection of air into a meltable wax such that it forms an aerated meltable wax; delivering the aerated meltable wax through one or more meltable wax delivery conduits to a meltable wax applicator; controlling movement of the object relative to the meltable wax applicator such that an at least one exposed surface of the object is fully engaged by at least a portion of the aerated meltable wax dispensing from an outlet of the meltable wax applicator.

In various embodiments, the computer program product, in particular the executable portions, may be further configured for executing steps and/or controlling any of the components provided in the associated method described elsewhere herein.

### BRIEF DESCRIPTION OF THE SEVERAL VIEWS OF THE FIGURES

Reference will now be made to the accompanying figures, which are not necessarily drawn to scale, and wherein:

FIG. 1 is a schematic diagram of a meltable wax application assembly.

FIG. 2 is a schematic diagram of a meltable wax application assembly.

FIG. 3 is a schematic diagram of a meltable wax application assembly.

FIGS. 4A and 4B are each a schematic diagram of a meltable wax air injection system.

FIG. 5 is a schematic diagram of a meltable wax air injection system.

FIG. 6 is a schematic diagram of a meltable wax air injection system.

FIG. 7 is an exemplary illustration of a meltable wax applicator and a plurality of objects positioned to interact with the applicator.

FIG. 8 is a schematic diagram of various components of an embodiment of a meltable wax application assembly.

FIG. 9 is a schematic diagram of various components of an embodiment of a meltable wax application assembly.

FIG. 10 is a schematic diagram of various components of an embodiment of a meltable wax application assembly.

FIG. 11 shows a graphical representation of the data collected in an experimental trial of an embodiment of the claimed invention.

FIGS. 12A-12D show graphical representations of the data collected in an experimental trial of an embodiment of the claimed invention.

FIG. 13 shows a graphical representation of the data collected in an experimental trial of an embodiment of the claimed invention.

FIG. 14 shows a graphical representation of the data collected in an experimental trial of an embodiment of the claimed invention.

FIGS. 15A-15C show graphical representations of the data collected in an experimental trial of an embodiment of the claimed invention.

### DETAILED DESCRIPTION

The present invention will now be described more fully hereinafter with reference to the accompanying figures, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

### Overview

Various embodiments of the present invention are directed to an aeration assembly and method for incorporating air into a water-resistant agent (e.g., a paraffin, tallow-based, or other wax, a calcium carbonate-wax blend, a resin, a polymer) to form an aerated solution. Although this description describes an input to the device as air, it should be understood that any gas may be utilized as an input for the system (e.g., carbon dioxide, oxygen, nitrogen, and/or the like). For example, air may be incorporated into a meltable coating such as a paraffin, tallow-based, or other wax, a calcium carbonate-wax blend, a resin, or a polymer.

The aerated meltable wax application assembly is configured to incorporate air into a meltable wax and thereby generate an aerated meltable wax having a lower density than the input wax. The resulting aerated meltable wax includes a plurality of air bubbles incorporated throughout the meltable wax, and therefore the wax has a decreased density compared to the wax entering the assembly at the meltable wax input conduit. The air bubbles are incorporated into the aerated meltable wax such that the bubbles remain in the wax while the wax sets into a final, solid state.

The disclosed method of aerating a meltable wax and applying it to an object may or may not be configured to support the above-referenced aerated meltable wax application assembly.

### Assembly

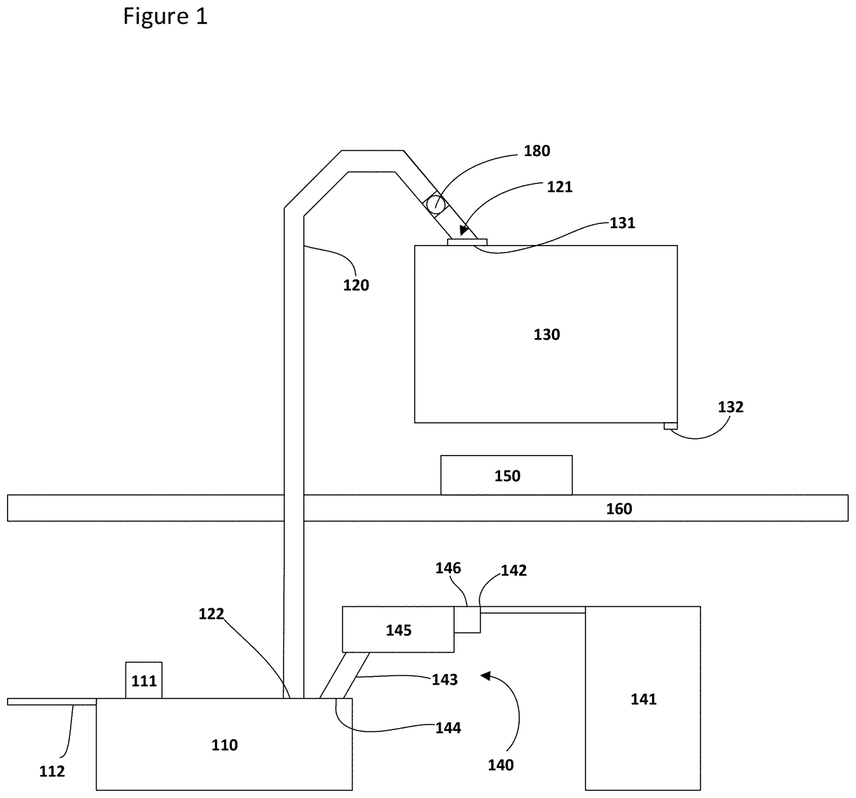

FIG. 1 is a schematic diagram of a meltable wax application assembly according to one embodiment of the present invention. As shown in FIG. 1, the air injection system 140 is positioned such that the one or more air injector outlets 144 are upstream from both the first and the second ends of the meltable wax delivery conduit 121, 122. In the illustrated embodiment, the one or more air injector outlets 144 may be positioned within the holding tank 110 proximate the second end of the delivery conduit 120 such that air from the air injection system 140 is injected into the meltable wax immediately before it enters the delivery conduit 120. FIGS. 1-3 depict an air injection system 140 that comprises an air inlet 142 configured so as to fluidly connect an air source 141 to an air pulsing device 145. The air source 141 may be a fixed factory air supply line or a free-standing air compressor. In various embodiments, a free-standing air compressor may be used to provide a dryer, purer source of air. As depicted, the air pulsing device 145 is coupled to an air delivery conduit 143 that is configured to direct the pulsed air from the air pulsing device 145 to the one or more air injector outlets 144. In various embodiments, the air injection system 140 may comprise one or more air pulsing devices 145 and one or more air delivery conduits 143 coupled to one or more air injector outlets 144. In various embodiments, the one or more air delivery conduits 143 may be either rigid or flexible such that the one or more conduits 143 may be bent and positioned so as to place the one or more air injector outlets 144 in a position that may otherwise difficult to access. The one or more rigid air delivery conduits 143 may be one or more of a straight configuration, a “U”-shaped configuration, an “L”-shaped configuration, or any other configuration that allows the one or more air injector outlets 144 to be positioned proximate the second end of the one or more wax delivery conduits 122. In various embodiments, the one or more air delivery conduits 143 may comprise interchangeable components and a fitting (not shown) configured to facilitate an easy exchange between, for example, flexible an rigid conduit components. Further, it is to be understood that while the description above discloses an assembly and a method comprised of only a single meltable wax delivery conduit 120, the scope of the invention disclosed should not be limited to an assembly and method using only a single delivery conduit to transport meltable wax from a holding tank to an applicator, but rather any number of meltable wax delivery conduits 120 may be used (e.g., two, three, four, etc.).

In various embodiments, the air pulsing device 145 may be coupled to an air source 141 via an air intake 142, the air source 141 producing air to the pulsing device 145 at a pressure of between 50-150 psi. The air pulsing device 145 may pulse air from the air source 141 out into the air delivery conduit 143 and to the one or more air injector outlets 144 at a pressure of between 50-150 psi (e.g., 120-140 psi). In various embodiments, the air pulsing device may pulse air at a rate of 0 to 3 pulses per second (e.g., 2 pulses per second). As a non-limiting example, the resulting wax-air solution may comprise greater than or less than approximately 18% air by volume (e.g., 5%-8%, 5%-20%).

As shown in FIGS. 1-3, air injection system 140 may further comprise one or more pressure gauges 146 positioned upstream from the air pulsing device 145 proximate the air inlet 142 configured to indicate the input pressure of the air from the air source 141. In various embodiments, the one or more pressure gauges 146 may additionally comprise a user control (not shown) (e.g., as a non-limiting example, a knob) to allow a user of the assembly to manually adjust the air input pressure at the air injection system 140. In various embodiments, the air injection system 140 may be at least in part computer-controlled. For example, the air input pressure or the air pulse rate may be controlled by a computerized controller configured to ensure that the air input pressure and pulse rate is sufficient to provide an aerated meltable wax having a pre-determined density. For example, the computerized controller may be configured to change the air input pressure or air pulse rate in order to change the density of the resulting aerated meltable wax. For example, increasing the air input pressure and/or pulse rate may result in a wax-air solution having a decreased density. In various embodiments, the computer controller may be configured to determine an optimal air input pressure and/or air pulse rate to provide a user-selected wax-air solution density.

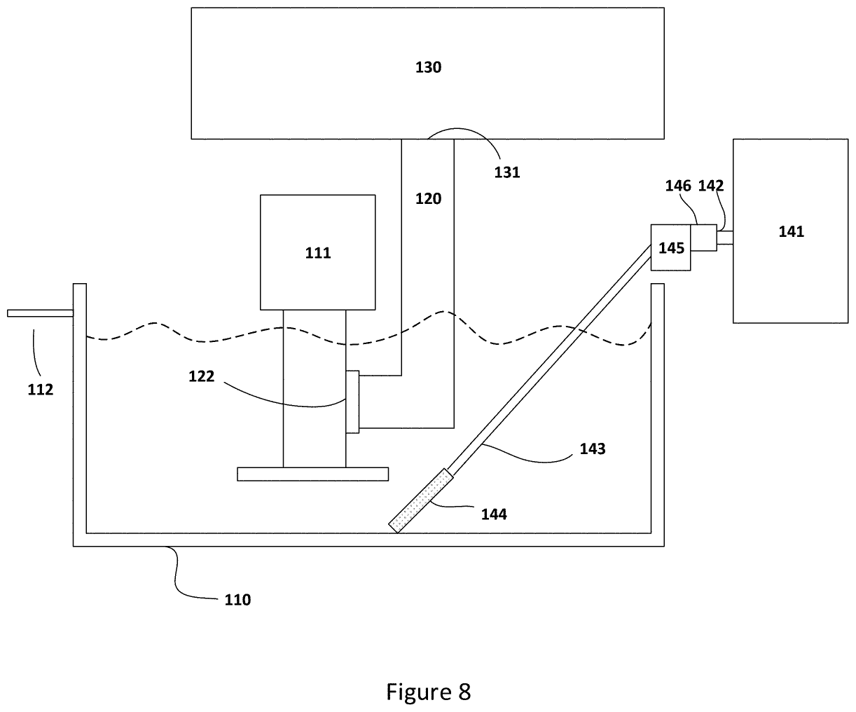

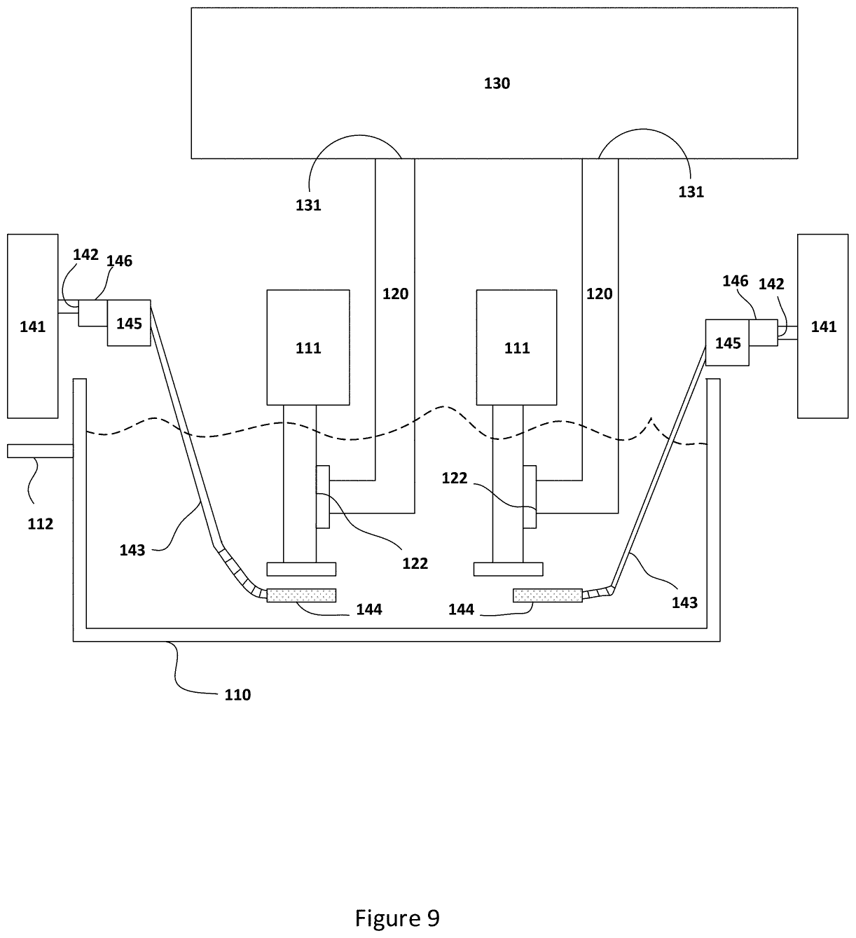

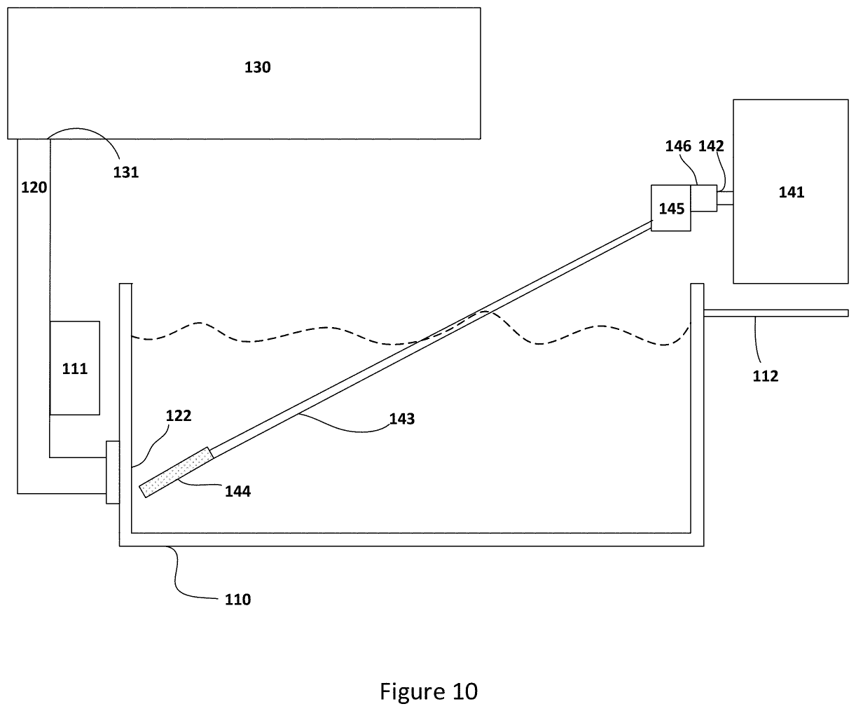

As illustrated in FIGS. 1-3, the holding tank 110 may receive wax from a wax inlet conduit 112 and may be positioned below the meltable wax applicator 130 such that a pump 111 may be used to drive the meltable wax through the delivery conduit 120 and to the applicator inlet 131 positioned proximate the first end of the delivery conduit 121. The pump 111 may be positioned adjacent the wax holding tank 110 and/or configured in-line with the wax inlet conduit 112. Further, the holding tank 110 may be positioned proximate the second end of the delivery conduit 122 such that meltable wax may be directed from the holding tank 110 into the delivery conduit 120. In various embodiments, as shown in FIGS. 1-3, the holding tank 110 may be configured to hold between 25-200 gallons (e.g., 50-100 gallons) of meltable wax so as to facilitate optimal mixing of air from the air injection system 140 and meltable wax present in the holding tank 110. In various embodiments, the pump 111 may comprise a pump intake mechanism positioned within the meltable wax in the wax holding tank 110. Further, in various embodiments, as shown in FIGS. 8-10, the pump 111 may be positioned at least substantially adjacent the second end of the meltable wax delivery conduit 122. It is to be understood that while the description above discloses an assembly and a method comprised of only a single pump 111, the scope of the invention disclosed should not be limited to an assembly and method using only a single pump to drive meltable wax from a holding tank into a meltable wax delivery conduit, but rather any number of pumps 111 may be used (e.g., two, three, four, etc.). In a particularly exemplary embodiment, the number of pumps used in the disclosed invention is equal to the number of meltable wax delivery conduits being used.

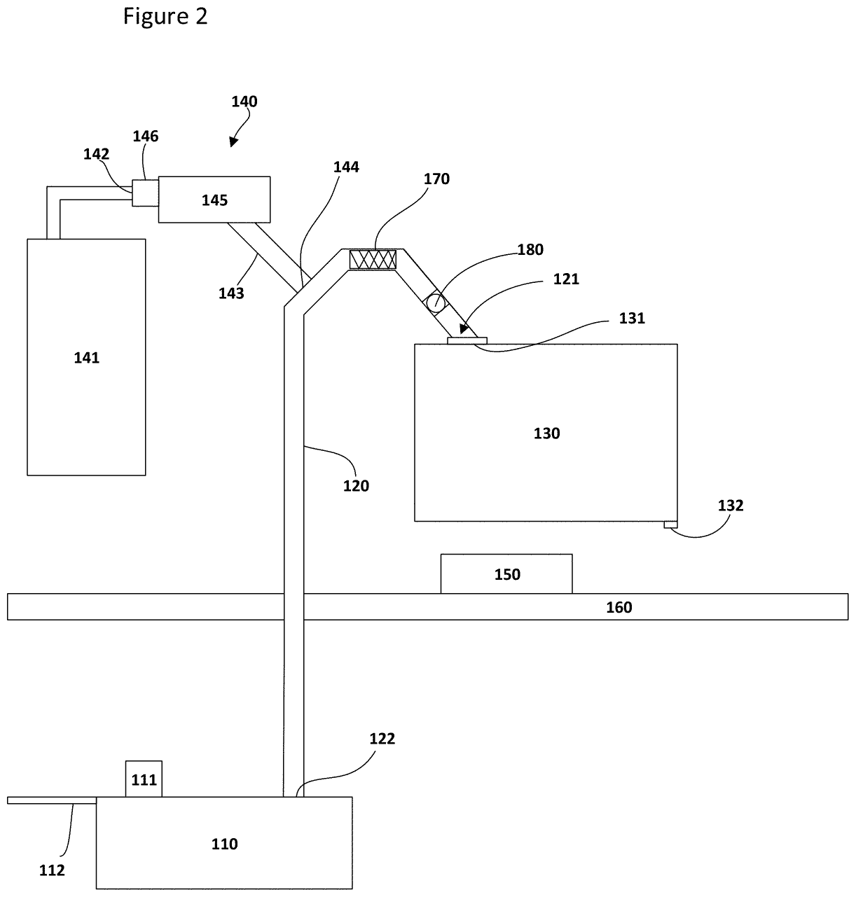

Moreover, as shown in FIG. 2, the aerated meltable wax application assembly may comprise an inline mixer 170 configured to mix the air and the meltable wax to create an aerated meltable wax having a lower density than the meltable wax entering meltable wax application assembly. The inline mixer 170 may comprise a static mixer configured to mix one or more fluids (e.g., air and melted wax) by directing the one or more fluids through a tortuous path causing the fluids to undergo turbulence to mix the one or more fluids. For example, the inline mixer 170 may comprise a plurality of contoured elements configured to direct the fluids to alternatingly rotate in a clockwise and counter-clockwise direction while advancing through the delivery conduit 120. In various embodiments, each of the plurality of contoured elements may comprise helical-shaped plates rotated between opposing ends. As a non-limiting example, each contoured element may rotate 90 degrees between a first end and a second end. Moreover, a plurality of contoured elements may be secured relative to one another to create an elongated tortuous path. Adjacent ends of adjacent contoured elements may be secured at an angle relative to one another. For example, each contoured element may be fixedly secured at a 90 degree angle relative to adjacent contoured elements. Moreover, each contoured element may comprise a generally rectangular element that has been twisted to form the helical-shape. However, any of a variety of shapes may be utilized, including triangular, diamond-shaped, and/or the like. The contoured elements cause the wax solution and the air to be further mixed together as the wax solution and air advance through the delivery conduit 120 without requiring externally supplied power. In various embodiments, the inline mixer 170 may have a cross sectional size substantially the same as the interior cross-section of the delivery conduit 120, such that substantially all of the aerated meltable wax moving through the delivery conduit 120 is directed through the contoured elements.

In various embodiments, the inline mixer 170 may comprise a plurality of stainless-steel contoured elements, although other materials are also contemplated (e.g., plastic, aluminum, and/or the like). Moreover, the diameter of the contoured elements may be sized such that the inline mixer 170 resides within the assembly with minimal clearance between the interior walls of the delivery conduit 120 and the contoured elements, such that substantially all of the wax and air is directed through the contoured elements. In various embodiments, the inline mixer 170 may be secured within the delivery conduit 120 such that the inline mixer 170 may be prevented from rotating and/or sliding within the delivery conduit 120. However, in various embodiments, the inline mixer 170 may be slidably and/or rotatably positioned within the delivery conduit 120 such that the inline mixer 170 may slide and/or rotate within the delivery conduit 120. Moreover, although not shown, a plurality of inline mixers 170 may be provided within the delivery conduit 120. For example, the plurality of inline mixers 170 may be positioned in series within the delivery conduit 120 such that one or more fluids (e.g., melted wax and air) flows through a first inline mixer 170 and then flows through a second inline mixer 170. In various embodiments, the plurality of inline mixers 170 may be provided in parallel, such that a plurality of inline mixers are positioned at least partially adjacent, such that one or more fluids flow along at least a portion of the length of the plurality of inline mixers simultaneously.

In various embodiments, the inline mixer 170 may be located along a portion of the wax travel path between the first end 121 and the second end 122 of the delivery conduit 120. For example, the inline mixer 170 may be within one or more straight portions of the delivery conduit 120. As shown in FIG. 2, the inline mixer 170 may be positioned downstream from the one or more air injector outlets 144 of the air injection system 140. In various embodiments where the air injection system 140 is positioned in-line with the wax inlet conduit 112, the inline mixer may be located along a portion of the wax inlet conduit 112 and may be positioned downstream from the air injection system 140 and either upstream or downstream from the pump 111.

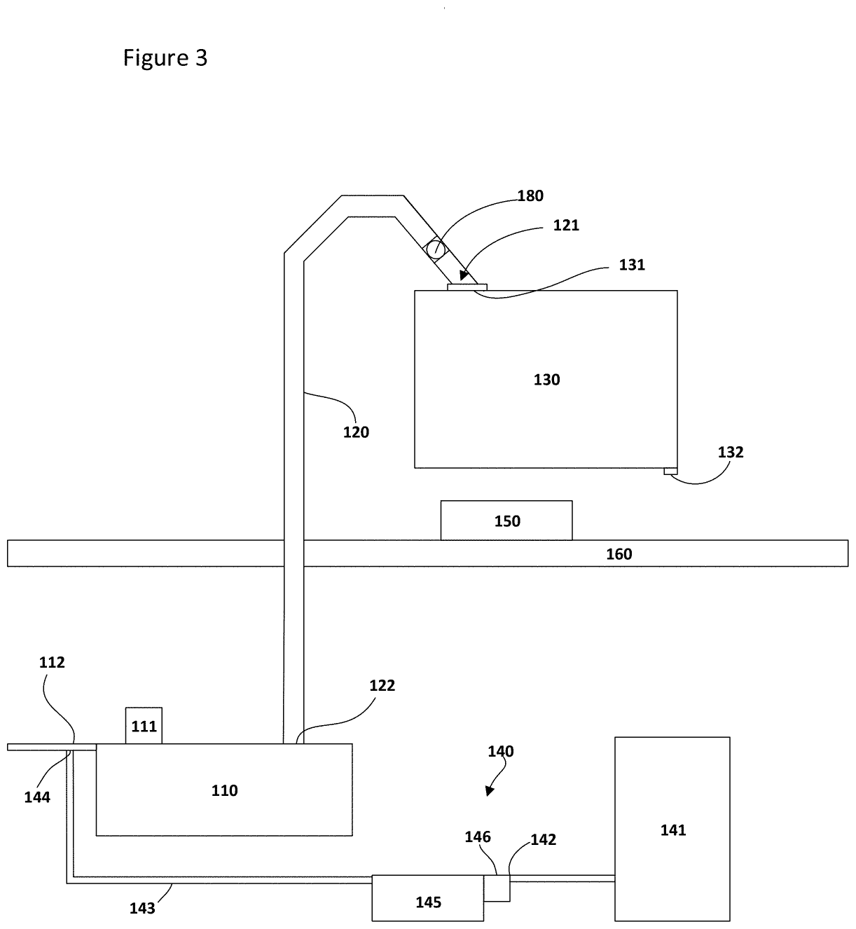

In various embodiments, as shown in FIGS. 1 and 3, the aerated meltable wax applicator assembly may not comprise an inline mixer and accordingly, the assembly may provide for sufficient mixing of the air bubbles formed by the input of air from the air injection system 140 into the flowing meltable wax without the inline mixer.

In various embodiments, as shown in FIGS. 1-3, the aerated meltable wax application assembly may further comprise one or more sensors 180 positioned downstream from the air injection system 140 proximate the inlet 131 of the meltable wax applicator 130 configured to indicate the density of the aerated meltable wax before the meltable wax flows into the applicator 130. In various embodiments, the sensor 180 may be positioned within the delivery conduit 120 and may be positioned either before or after an inline mixer 170. In various embodiments, the sensor 180 may be at least in part computer-controlled and/or in communication with a computer-controlled air injection system 140. For example, the air input pressure or the air pulse rate may be controlled by a computerized controller configured to ensure that the air input pressure and pulse rate is sufficient to provide an aerated meltable wax having a pre-determined density. The sensor 180 may be configured to detect a difference between the actual density and the desired density of the aerated meltable wax and may communicate with the air injection system 140, which may adjust any of its critical input variables (e.g., air pressure, pulse rate) accordingly. In various embodiments, the computer controller may be configured to determine an optimal air input pressure and/or air pulse rate to provide a user-selected wax-air solution density.

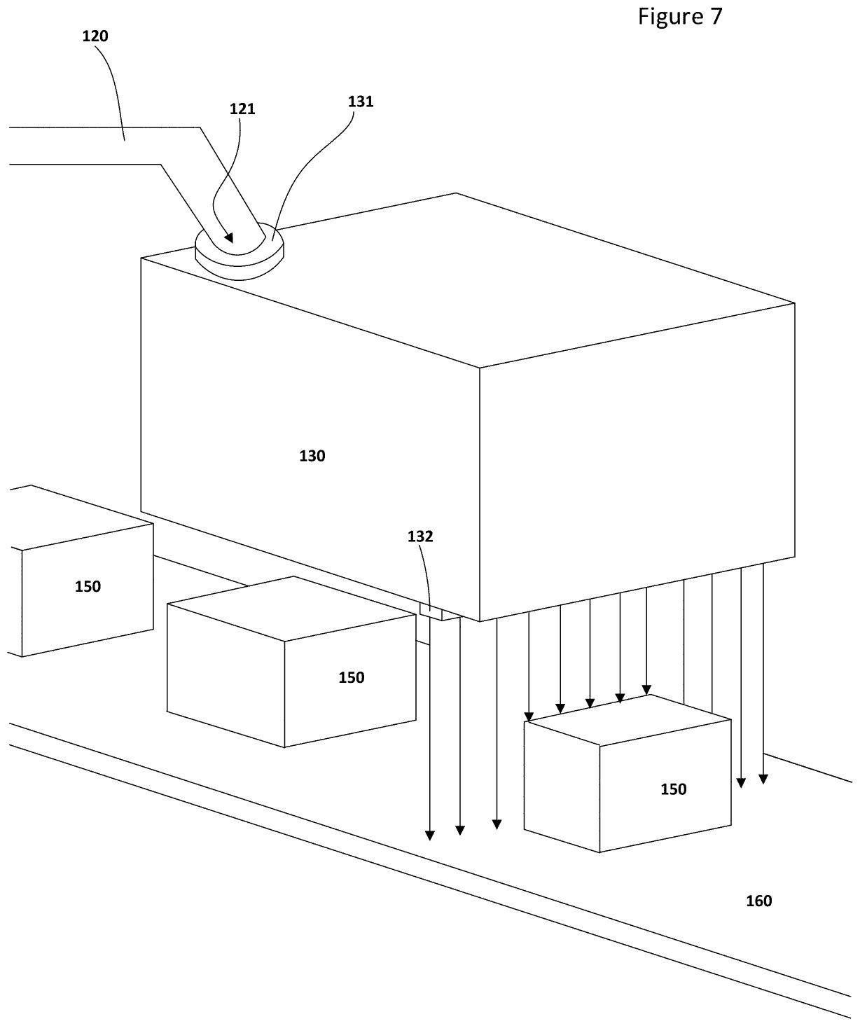

In a particularly exemplary embodiment, the aerated meltable wax applicator 130 may be a wax cascading machine (i.e. a “wax cascader”), such as the apparatus disclosed in Stease in U.S. Pat. Nos. 3,635,193 and 3,793,056 and Gjeadel in U.S. Pat. No. 3,343,977. As shown in FIGS. 1-3 and 7, the applicator 130 may be coupled to the delivery conduit 120 such that the first end of the deliver conduit 121 is proximate the meltable wax inlet 131 of the applicator 130, allowing aerated meltable wax to flow from the delivery conduit 120 into the applicator 130. The aerated meltable wax flows out of the meltable wax outlet 132 of the applicator 130 and may be vertically and downwardly dispensed so as to create a cascading fluid path (i.e. a “waterfall” effect). As shown in FIG. 7, an object 150 may be placed on a surface 160 and arranged relative to the aerated meltable wax outlet 132 of the applicator 130 such that the dispensed aerated meltable wax may contact and adhere to at least one exposed surface of the object 150. It is to be understood that while the embodiment described above discloses an assembly comprising a cascading wax applicator, the scope of the invention disclosed should not be limited to using a cascading wax applicator to apply aerated meltable wax to an object, but rather should also include embodiments wherein a curtain wax applicator or a wax impregnator may be used, as such devices are commonly known and understood to be used for wax application.

FIG. 2 is a schematic diagram of a meltable wax application assembly according to one embodiment of the present invention. As shown in FIG. 2, the air injection system 140 is positioned such that the one or more air injector outlets 144 are upstream from the first end of the meltable wax delivery conduit 121 and downstream from the second end of the fluid delivery conduit 122, such that the meltable wax may be aerated while flowing through the meltable wax delivery conduit 120. In the illustrated embodiment, the one or more air injector outlets 144 may be positioned within the delivery conduit 120, in line with the meltable wax flow path such that meltable wax flows around at least a portion of the one or more air injector outlets 144 and air from the air injection system 140 is injected into the meltable wax while the meltable wax flows through the delivery conduit 120. As discussed herein, as the meltable wax flows around the one or more air injector outlets 144, the air may enter the meltable wax through the injector outlet 144 to form small bubbles in the wax. As the wax flows through the delivery conduit 120 with the small air bubbles formed therein, the air bubbles may become mixed (e.g., distributed) throughout the meltable wax to lower the overall density of the aerated meltable wax. In various embodiments, the inline mixer 170 may be located along a portion of the fluid travel path between the first end 121 and the second end 122 of the delivery conduit 120. The inline mixer 170 may be positioned downstream from the one or more air injector outlets 144 of the air injection system 140. Further, in various embodiments, the aerated meltable wax application assembly may further comprise a sensor 180 positioned downstream from the air injection system 140 proximate the inlet 131 of the meltable wax applicator 130 configured to indicate the density of the aerated meltable wax before the meltable wax flows into the applicator 130. All components disclosed, but not specifically referenced in the above description of the embodiment illustrated in FIG. 2 should be understood to be substantially the same as those components described with respect to FIG. 1. All embodiments should be understood to be substantially the same with the exception of the distinguishing description of the paragraph above.

FIG. 3 is a schematic diagram of a meltable wax application assembly according to one embodiment of the present invention. As shown in FIG. 3, the air injection system 140 is positioned such that the one or more air injector outlets 144 are upstream from the wax holding tank 110 such that the meltable wax may be aerated while flowing through a meltable wax inlet conduit 112 prior to entering the holding tank 110. In the illustrated embodiment, the one or more air injector outlets 144 may be positioned within the wax inlet conduit 112, in line with the meltable wax flow path such that meltable wax flows around at least a portion of the one or more air injector outlets 144 and air from the air injection system 140 is injected into the meltable wax while the meltable wax flows through the wax inlet conduit 112. As discussed herein, as the meltable wax flows around the one or more air injector outlets 144, the air may enter the meltable wax through the injector outlet 144 to form small bubbles in the wax. As the wax flows through the wax inlet conduit 112 with the small air bubbles formed therein, the air bubbles may become mixed (e.g., distributed) throughout the meltable wax to lower the overall density of the aerated meltable wax. In various embodiments, the one or more air injector outlets 144 may be positioned in-line with the pump 111, either upstream or downstream from the pump. All components disclosed, but not specifically referenced in the above description of the embodiment illustrated in FIG. 3 should be understood to be substantially the same as those components described with respect to FIG. 1. All embodiments should be understood to be substantially the same with the exception of the distinguishing description of the paragraph above.

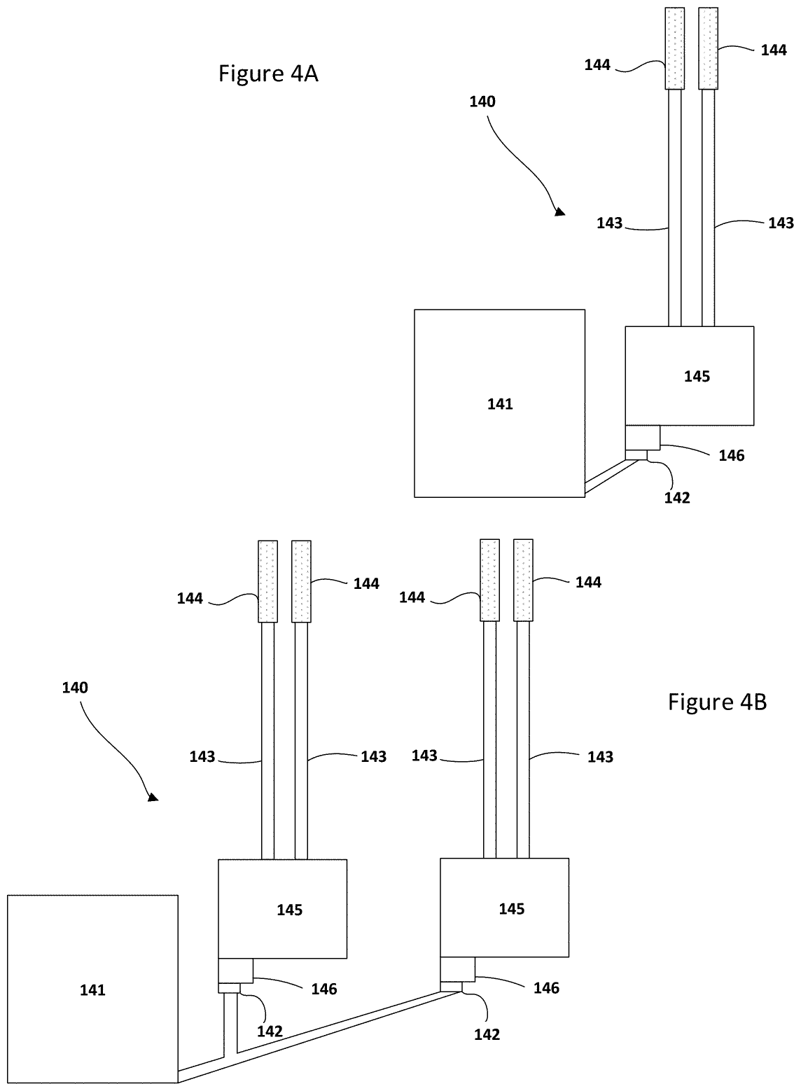

FIGS. 4A and 4b are each a schematic diagram of an air injection system 140 coupled to an air source 141 according to one embodiment of the present invention. In various embodiments, the air injection system 140 comprises an air inlet 142 configured to receive air from the air source 141 and direct the air to one or more air pulsing devices 145. As illustrated in the embodiment of FIG. 4A, the air injection system 140 comprises a single air pulsing device 145. In various embodiments, the air injection system 140 may comprise more than one air pulsing device 145. In various embodiments, the one or more air pulsing devices 145 may comprise, for example, two, four, six, eight, or more air pulsing devices 145. For example, the exemplary embodiment illustrated in FIG. 4b comprises two air pulsing devices 145. As shown in FIGS. 4A-6, various embodiments of the air injection system 140 may comprise one or more pressure gauges 146 positioned upstream from the one or more air pulsing devices 145 proximate the air inlet 142 configured to indicate the input pressure of the air from the air source 141. The one or more air pulsing devices 145 may be coupled to one or more air delivery conduits 143 configured to direct air from the one or more pulsing devices 145 to the one or more air injector outlets 144. The one or more air injector outlets 144 are configured to inject air directly into the meltable wax so as to create an aerated meltable wax. In various embodiments, the one or more air injector outlets 144 may comprise, for example, two, four, six, eight, or more air injector outlets 144.

In various embodiments, an air injector outlet 144 may comprise an air nozzle configured such that the meltable wax flows around at least a portion of the air nozzle such that the meltable wax and the air mix to form an aerated meltable wax. Further, as shown in FIGS. 4A-6, the air nozzle may comprise an air diffuser defining a plurality of entry openings, which may have a maximum hydraulic diameter of about 20 microns, through which the air flows into the surrounding meltable wax to form air bubbles within the wax flowing around the air diffuser. In various embodiments, the entry openings have a maximum hydraulic diameter of at least substantially 20 microns. For example, the SD-12: 12-in Stainless Steel Diffuser, by Ozone Solutions, Inc. of Hull, Iowa may be used to direct air into the surrounding meltable wax. Of course, alternative hydraulic diameters may be utilized, as desirable. Still further, although the example diffuser comprises a stainless-steel material, other materials are also contemplated (e.g., aluminum, ceramic, and/or the like).

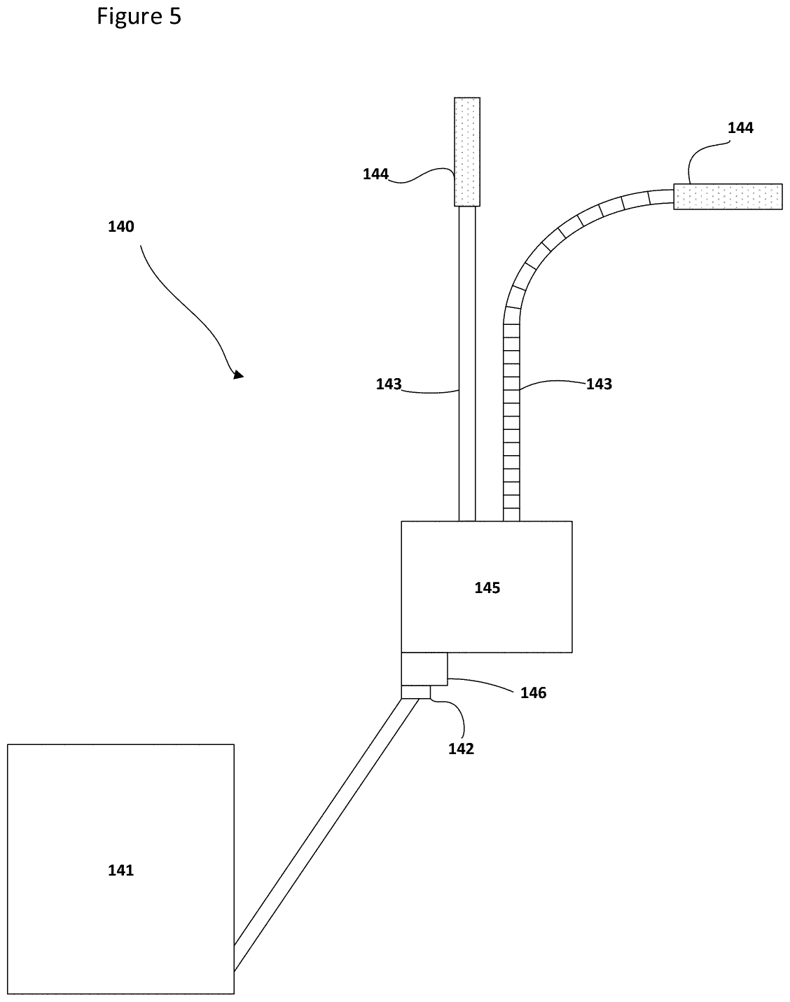

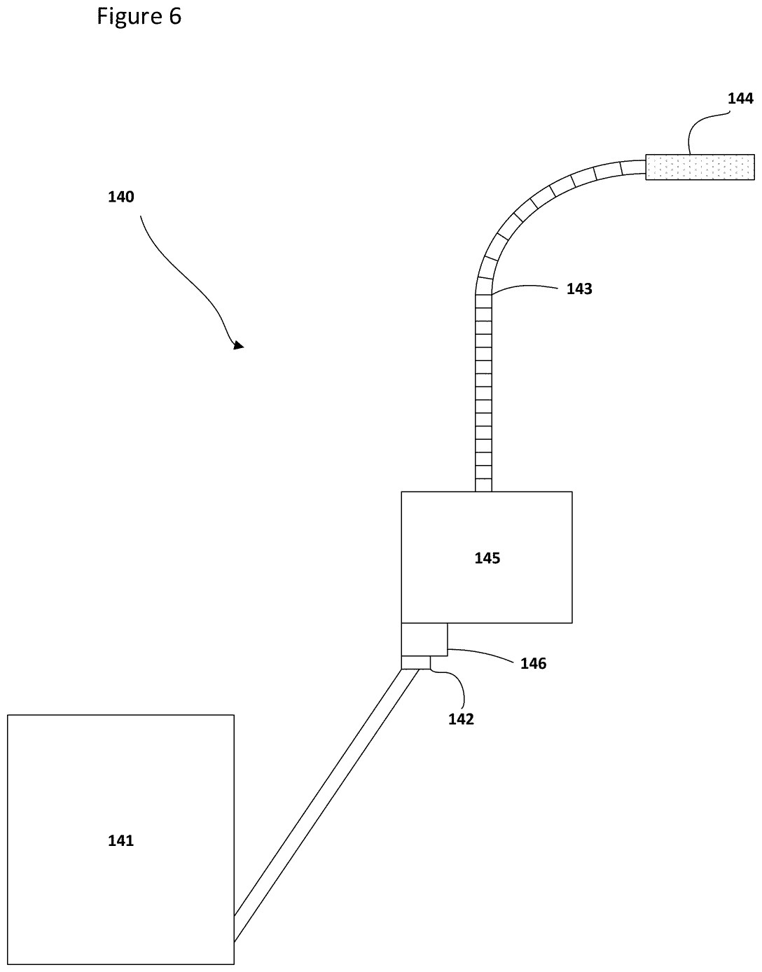

As shown in FIGS. 4A-6, in various embodiments, the one or more air delivery conduits 143 may be either rigid or flexible such that the one or more conduits 143 may be bent and positioned so as to place the one or more air injector outlets 144 in a position that may otherwise difficult to access. The one or more rigid air delivery conduits 143 may be one or more of a straight configuration, a “U”-shaped configuration, an “L”-shaped configuration, or any other configuration that allows the one or more air injector outlets 144 to be positioned proximate the second end of the one or more wax delivery conduits 122. In various embodiments, the one or more air delivery conduits 143 may comprise interchangeable components and a fitting (not shown) configured to facilitate an easy exchange between, for example, flexible and rigid conduit components. FIG. 5 in particular illustrates an embodiment wherein the air injection system 140 comprises two air delivery conduits 143: one rigid conduit and one flexible conduit. FIG. 6 in particular illustrates an embodiment wherein the air injection system 140 comprises only a single flexible air delivery conduit 143.

It is to be understood that while the particularly exemplary embodiment discloses an aerated meltable wax application assembly, the scope of the invention disclosed should not be limited to an assembly for the aeration and application of wax, but rather any material which may experience a desired reduction in density as a result of aeration.

As shown in FIGS. 1-3, various components of the disclosed assembly may also comprise rigid tubing members. The wax inlet conduit 112, the wax delivery conduit 120, and the air delivery conduit 143 may each comprise a plurality of stainless steel pipe members and fittings configured to be threaded together. For example, each of the plurality of stainless steel pipe members may comprise male threads located on each end of the pipe member that are configured to interlock with female threads located on the interior of each pipe fitting. In various embodiments, a plurality of rigid tubing members may be configured to be coupled together such that the contents within the wax inlet conduit 112, the wax delivery conduit 120, and the air delivery conduit 143 (e.g., meltable wax and air) are prevented from escaping through the interfaces between any rigid tubing members without additional sealing members (e.g., O-rings, gaskets, and/or the like). Various components of the disclosed aerated meltable wax application assembly may additionally be coupled together with a plurality of alternative fasteners (e.g., welding or the like). While the particularly exemplary embodiment discloses a wax inlet conduit 112, wax delivery conduit 120, and air delivery conduit 143 comprised of stainless steel pipe and stainless steel pipe fittings, other materials and types of rigid tubing members are also contemplated (e.g., plastic, brass, aluminum, and/or the like).

Various embodiments of the disclosed aerated meltable wax application assembly may be selectively disassembled for cleaning and component replacement. For example, in embodiments of the wax inlet conduit 112, wax delivery conduit 120, and air delivery conduit 143 comprising a plurality of stainless steel pipe components coupled to a plurality of pipe fittings using threaded connections, each of the components may be unscrewed from one another for disassembly.

### Method of Use

In various embodiments, an aerated meltable wax may be created by supplying the above-disclosed aerated meltable wax application assembly with a meltable wax and air in order to create a final aerated meltable wax having a lower density than the originally supplied wax.

In various embodiments, an aerated meltable wax may be created and applied to an object by injecting air into a meltable wax, resulting in an aerated meltable wax; delivering the aerated meltable wax through a meltable wax delivery conduit 120 and to a meltable wax applicator 130; and dispensing the aerated meltable wax from an outlet 132 of the meltable wax applicator 130 and onto an object 150 positioned adjacent the meltable wax applicator 130, such that the aerated meltable wax contacts and adheres to at least one exposed surface of the object 150.

In various embodiments, as shown in FIGS. 1-3 and 8-10, the holding tank 110 containing the meltable wax may receive wax from a wax inlet conduit 112 and may be positioned below the meltable wax applicator 130 such that a pump 111 may be used to drive and/or pull the meltable wax into and through the delivery conduit 120 and to the applicator inlet 131 positioned proximate the first end of the delivery conduit 121. The pump 111 may be positioned adjacent the wax holding tank 110 and/or configured in-line with the wax inlet conduit 112. Further, the holding tank may be positioned proximate the second end of the delivery conduit 122 such that meltable wax may be directed from the holding tank 110 into the delivery conduit 120. In various embodiments, as shown in FIGS. 1-3 and 8-10, the holding tank 110 may be configured to hold between 25-200 gallons (e.g., 50-100 gallons) of meltable wax so as to facilitate optimal mixing of air from the air injection system 140 and meltable wax present in the holding tank 110.

In various embodiments, as shown in FIGS. 8-10, the pump 111 may be positioned at least substantially adjacent the second end of the meltable wax delivery conduit 122. As mentioned above, it is to be understood that while the description above discloses an assembly and a method comprised of only a single pump 111, the scope of the invention disclosed should not be limited to an assembly and method using only a single pump to drive meltable wax from a holding tank into a meltable wax delivery conduit 120, but rather any number of pumps 111 may be used (e.g., two, three, four, etc.). In a particularly exemplary embodiment, the number of pumps used in the disclosed invention is equal to the number of meltable wax delivery conduits 120 being used.

In various embodiments, air is injected into the meltable wax with an air injection system 140, wherein the air injection system may comprise an air inlet 142, through which air flows into a first end of an one or more air delivery conduits 143, and one or more air injector outlets 144 coupled to a second end of the one or more air delivery conduits 143. In various embodiments, an air injector outlet 144 may comprise an air nozzle configured such that the meltable wax flows around at least a portion of the air nozzle such that the meltable wax and the air mix to form an aerated meltable wax. Further, as shown in FIGS. 4A-6, the air nozzle may comprise an air diffuser defining a plurality of entry openings, which may have a maximum hydraulic diameter of about 20 microns, through which the air flows into the surrounding meltable wax to form air bubbles within the wax flowing around the air diffuser. In various embodiments, the entry openings have a maximum hydraulic diameter of at least substantially 20 microns.

In various embodiments, the air injection system 140 may further comprise one or more air pulsing devices 145 positioned between the air inlet 142 and the one or more air delivery conduits 143 such that the one or more air pulsing devices 145 may selectively provide a variable volume of air from the air inlet 142 through the one or more air delivery conduits 143 and to the one or more air injector outlets 144. In various embodiments, the air injection system may further comprise a pressure gauge 146 positioned upstream from the air pulsing device 145 proximate the air inlet 142 that indicates the input pressure of the air from the air source 141.

In various embodiments, the air injection system 140 may be at least in part computer-controlled. For example, the air input pressure or the air pulse rate may be manipulated and/or otherwise managed—automatically or otherwise (e.g., dependent at least in part upon user interaction and/or authorization of activities conducted) by a computerized controller. In certain embodiments the controller may be configured to ensure that the air input pressure and pulse rate is sufficient to provide an aerated meltable wax having a pre-determined density. For example, the computerized controller may be configured to change the air input pressure or air pulse rate in order to change the density of the resulting aerated meltable wax. For example, increasing the air input pressure and/or pulse rate may result in a wax-air solution having a decreased density. In various embodiments, the computer controller may be configured to determine an optimal air input pressure and/or air pulse rate to provide a user-selected wax-air solution density.

In certain embodiments, the controller may be incorporated with a computer program product or the like. The computer program product may further include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The executable instructions (e.g., computer program instructions) may also be stored in a computer-readable memory that can direct a computer or other programmable data processing apparatus to function in a particular manner, such that the instructions stored in the computer-readable memory produce an article of manufacture including computer-readable instructions for implementing a desired functionality. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the desired functionality.

In certain embodiments, the computer program product may be connected further to a network, so as to facilitate wireless (or other) transmission of data, executable instructions, parameters, or the like. The one or more networks 130 may be capable of supporting communication in accordance with any one or more of a number of second-generation (2G), 2.5G, third-generation (3G), and/or fourth-generation (4G) mobile communication protocols, or the like. More particularly, the one or more networks 130 may be capable of supporting communication in accordance with 2G wireless communication protocols IS-136 (TDMA), GSM, and IS-95 (CDMA). Also, for example, the one or more networks 130 may be capable of supporting communication in accordance with 2.5G wireless communication protocols GPRS, Enhanced Data GSM Environment (EDGE), or the like. In addition, for example, the one or more networks 130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 320 may be configured to communicate with one another in accordance with techniques such as, for example, radio frequency (RF), Bluetooth™ infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Returning now to FIGS. 1-6 and 8-10, in various embodiments, the air injection system 140 may receive air from an air source 141 and pulse it into the meltable wax at a pressure of between 50-150 psi (e.g., 120-140 psi). In various embodiments, the air pulsing device 145 may pulse air at a rate of 0 to 3 pulses per second (e.g., 2 pulses per second). As a non-limiting example, the resulting aerated meltable wax may be greater than or less than approximately 18% air by volume (e.g., 5%-8%, 5%-20%). In an exemplary embodiment, the one or more air injector outlets 144 of the air injection system 140 may be positioned upstream from both the first and the second ends of the meltable wax delivery conduit 121, 122. The one or more air injector outlets 144 may be placed within the holding tank 110 proximate the second end of the meltable wax delivery conduit 122 such that the air from the air injection system 140 is injected into the meltable wax while the meltable wax is being stored in the holding tank 110, immediately before it is driven into the delivery conduit 120. The aerated meltable wax is then driven through the second end of the delivery conduit 122 by the pump 111 and delivered through a meltable wax delivery conduit 120 to a meltable wax applicator 130. In various embodiments, the second end of the delivery conduit 122 may define a meltable wax intake valve. The aerated meltable wax is then dispensed from an outlet 132 of the fluid applicator 130 and onto an object 150 positioned adjacent the meltable wax applicator 130, such that the aerated meltable wax contacts and adheres to at least one exposed surface of the object 150. In various embodiments, the position of the object 150 may be determined by the arrangement of an assembly line 160 that is configured to deliver the object 150 to its position adjacent the outlet of the applicator 130. In a particularly exemplary embodiment, the object 150 is a box. The box may be in a deconstructed state such that each of the sides of the box coplanar. Further, the box may be arranged in a flat or upright orientation such that at least one of the surfaces is positioned to receive meltable wax being dispensed out of the outlet 132 of the meltable wax applicator 130.

In various embodiments, as the aerated meltable wax advances through the delivery conduit 120 it may undergo further mixing as it interacts with an inline mixer 170 positioned in the delivery conduit 120. By interacting with a tortious fluid path and the plurality of contoured elements defined by the inline mixer 170, the aerated meltable wax is further mixed to create a substantially uniform distribution of air bubbles throughout the wax solution. The resulting aerated meltable wax is a wax-air solution having a lower density than the meltable wax supplied in the wax holding tank 110. As noted herein, the density of the aerated meltable wax may be modified at least in part by changing the air input pressure and/or the pulse rate of the air injector 140. Accordingly, a decreased amount of wax (as supplied to the wax input port) may be utilized for a similar application for coating various products, surfaces, and/or the like. In various embodiments, the amount of air injected into the wax may be adjusted manually or by an automated system configured to adjust the air injection setting within a predetermined range.

In various embodiments, the method may further comprise using a sensor 180 positioned within the meltable wax delivery conduit 120 and downstream from the air injection system 140 to determine the amount of air present in the meltable wax at a location along the meltable wax delivery conduit 120. The sensor 180 may be configured to detect a difference between the actual density and the desired density of the aerated meltable wax and may communicate with the air injection system 140, which may adjust any of its critical input variables (e.g., air pressure, pulse rate) accordingly.

Additionally, as shown in an exemplary embodiment in FIG. 2, the one or more air injector outlets 144 of the air injection system 140 may be positioned upstream from the first end of the meltable wax delivery conduit 121 and downstream from the second end of the fluid delivery conduit 122, such that the meltable wax may be aerated while flowing through the meltable wax delivery conduit 120. In such a configuration, the meltable wax is driven into the delivery conduit 120 by the pump 111 prior to its interaction with air injection system 140. The one or more air injector outlets 144 may be positioned within the delivery conduit 120, in line with the meltable wax flow path such that meltable wax flows around at least a portion of the one or more air injector outlets 144 and air from the air injection system 140 is injected into the meltable wax while the meltable wax flows through the delivery conduit 120. As discussed herein, as the meltable wax flows around the one or more air injector outlets 144, the air may enter the meltable wax through the one or more air injector outlets 144 to form small bubbles in the wax. As the wax flows through the delivery conduit 120 with the small air bubbles formed therein, the air bubbles may become mixed (e.g., distributed) throughout the meltable wax to lower the overall density of the aerated meltable wax; the wax may be impregnated with the air bubbles distributed throughout. In various embodiments, the inline mixer 170 may be located along a portion of the fluid travel path between the first end 121 and the second end 122 of the delivery conduit 120. The inline mixer 170 may be positioned downstream from the one or more air injector outlets 144 of the air injection system 140. Further, a sensor 180 may be positioned downstream from the air injection system 140 proximate the inlet 131 of the meltable wax applicator 130 configured to indicate the density of the aerated meltable wax before the meltable wax flows into the applicator 130.

It is to be understood that while the particularly exemplary embodiment discloses a method of aerating and applying meltable wax, the scope of the invention disclosed should not be limited to a method for the aeration and application of wax, but rather any material which may experience a desired reduction in density as a result of aeration.

It is to be understood that the present invention is not limited to the embodiments described above and illustrated in the drawings; rather, the skilled person will recognize that many changes and modifications may be made within the scope of the appended claims.

### Experimental Data

Experimental testing was conducted to verify the effectiveness of the claimed invention as described herein. Data was collected over the course of multiple trials using various combinations of embodiments described above. Critically, the effectiveness of the various embodiments described herein can be assessed—at least in part—by the extent to which applying an aerated meltable wax to an object reduces the amount of wax required to coat the object (i.e. the wax “pick-up”) without compromising the strength or integrity of the object. The wax pick-up of a particular object (e.g., a box) is determined by weighing the object both before and after the wax coating has been applied to determine the amount of wax remaining on the object post-coating; the “pick-up” represents the percentage of the total post-coating weight made up by the wax. The claimed invention reduces the wax pick up by strategically injecting air into the wax before the wax is applied to an object.

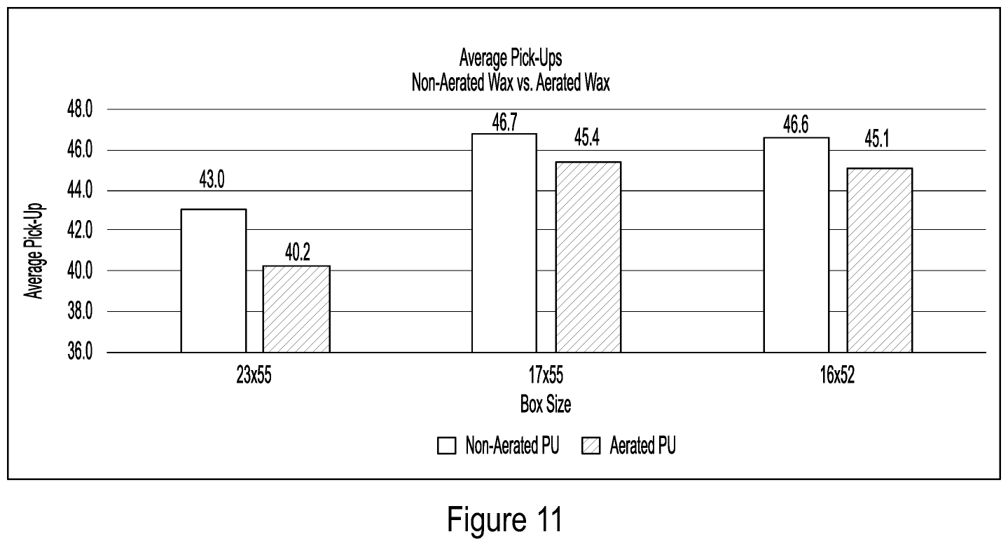

FIG. 11 shows a graphical representation of the data collected in one experimental trial of an embodiment of the claimed invention. The data represented by FIG. 11 was collected over the course of three days, using three different boxes types: a 23″×55″ squash box, a 17″×55″ vegetable box, and a 16″×52″ vegetable box. In this configuration, the air injection system comprised two air injector outlets, each comprising an air diffuser defining a plurality of entry openings, having a maximum hydraulic diameter of about 20 microns. The air diffuser was placed directly in the wax holding tank as close as possible to the second end of the delivery conduit. A steady stream of air from the air injection system was injected directly into the wax. The meltable coating used in this trial was a 100% tallow wax; the meltable wax applicator used was a wax cascader. As shown in FIG. 11, the claimed invention reduced the wax pick-up of the three box types by 2.8, 1.3, and 1.5 percentage points, respectfully. The results illustrated in FIG. 11 show an average wax pick-up reduction of 1.86% over the three-day trial.

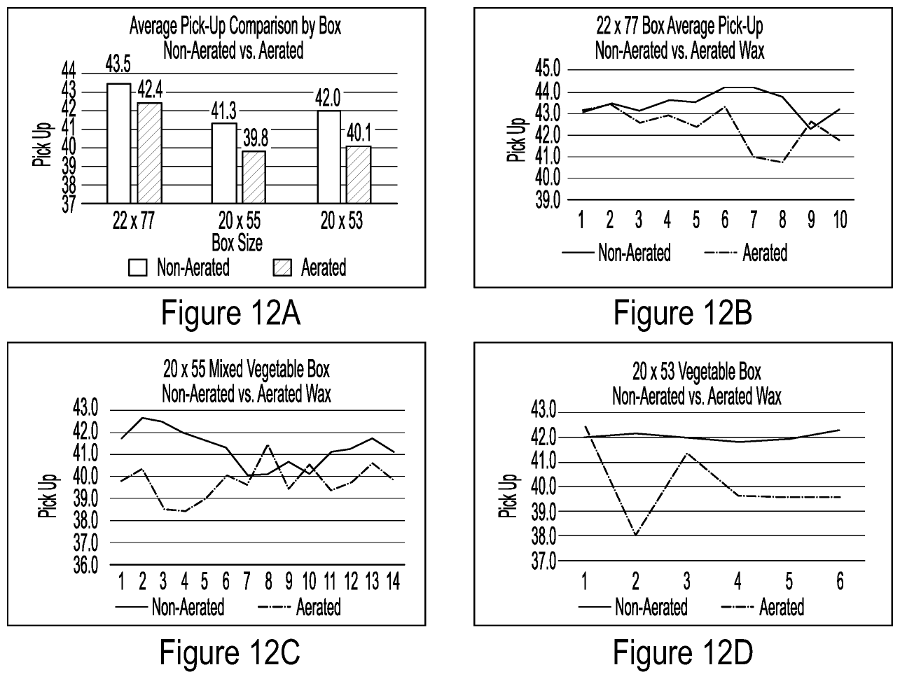

FIGS. 12a-12d show a graphical representation of the data collected in another experimental trial of an embodiment of the claimed invention. The data represented by FIGS. 12A-12D was collected over the course of three days, using three different boxes types: a 22″×77″ cabbage box, a 20″×55″ mixed vegetable box, and a 20″×53″ vegetable box. In this configuration, the air injection system comprised two air injector outlets, each comprising an air diffuser defining a plurality of entry openings, having a maximum hydraulic diameter of about 20 microns. The air diffuser was placed directly in the wax holding tank as close as possible to the second end of the delivery conduit. On the first day, a steady stream of air from the air injection system was injected into the wax, while on the second and third days, the air injection system comprised an air pulsator that pulsed the air into the wax. The meltable coating used in this trial was a 100% paraffin wax; the meltable wax applicator used was a wax cascader. As shown in FIGS. 12A-12D, the claimed invention reduced the wax pick-up of the three box types by 1.1, 1.5, and 1.9 percentage points, respectfully. The results illustrated in FIGS. 12A-12D show an average wax-pick up reduction of 1.5% over the three-day trial.

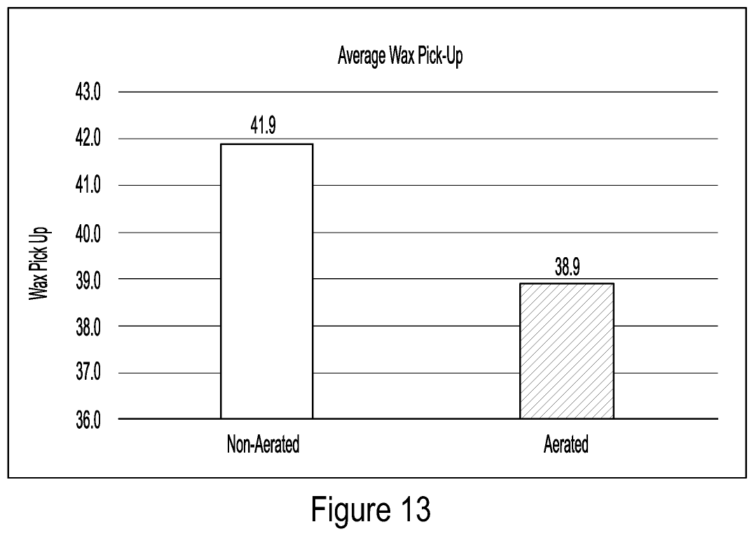

FIG. 13 shows a graphical representation of the data collected in yet another experimental trial of an embodiment of the claimed invention. The data represented by FIG. 13 was collected using a cauliflower box. In this configuration, the air injection system comprised two air injector outlets, each comprising an air diffuser defining a plurality of entry openings, having a maximum hydraulic diameter of about 2 microns (i.e. configured to create smaller bubbles than the air diffusers used in the two trials discussed above). The air diffuser was placed directly in the wax holding tank as close as possible to the second end of the delivery conduit. A steady stream of air from the air injection system was injected directly into the wax. The meltable coating used in this trial was a 100% paraffin wax; the meltable wax applicator used was a wax cascader. As shown in FIG. 13, the aerated wax resulted in an average pick-up of 38.9%, a reduction of 3.0 percentage points.

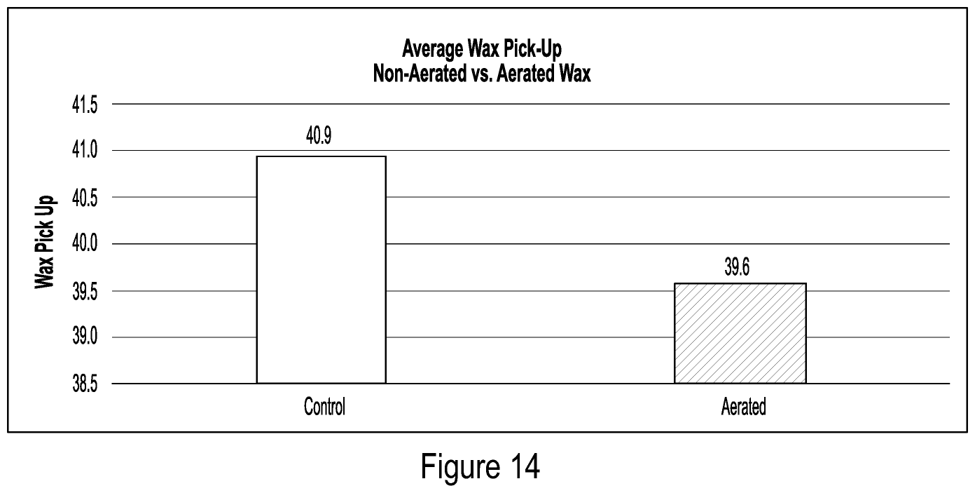

FIG. 14 shows a graphical representation of the data collected in another experimental trial of an embodiment of the claimed invention. The data represented by FIG. 14 was collected using a 40″×60″ vegetable box. In this configuration, the air injection system comprised two air injector outlets, each comprising an air diffuser defining a plurality of entry openings, having a maximum hydraulic diameter of about 20 microns. The air diffuser was placed directly in the wax holding tank as close as possible to the second end of the delivery conduit. A steady stream of air from the air injection system was injected directly into the wax. The meltable coating used in this trial was a 100% paraffin wax; the meltable wax applicator used was a wax cascader. As shown in FIG. 14, the aerated wax resulted in an average pick-up of 39.6%, a reduction of 1.4 percentage points.

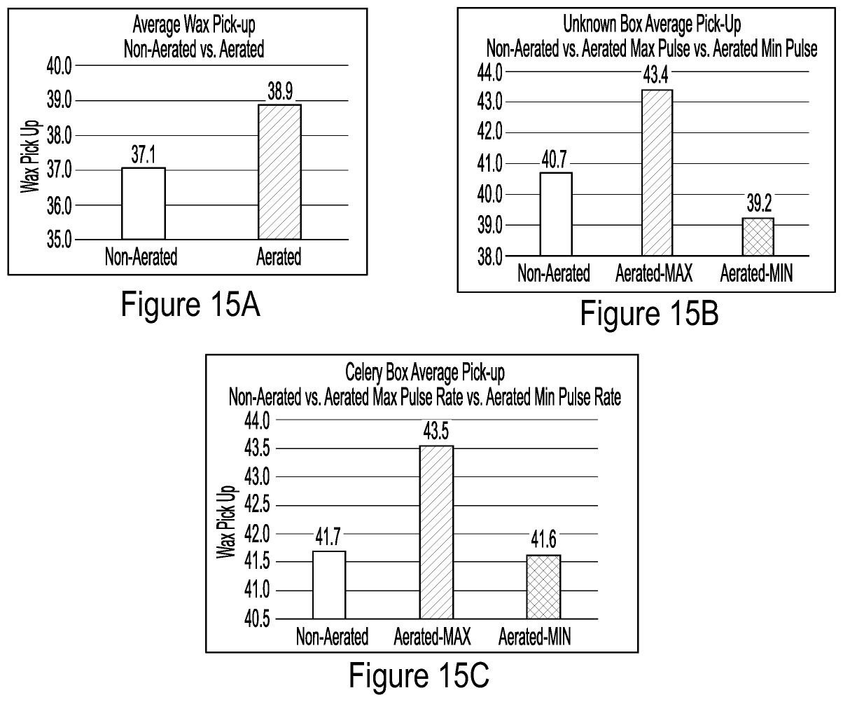

FIGS. 15a-15c shows a graphical representation of the data collected in a still further experimental trial of an embodiment of the claimed invention. In this configuration, the air injection system comprised two air injector outlets, each of which was arranged in an “in-line” configuration with a respective meltable wax delivery conduit. The two air injector outlets each comprised an air diffuser defining a plurality of entry openings, having a maximum hydraulic diameter of about 20 microns. The data represented by FIG. 15A was collected using an air injector system comprising two pulsator devices pulsing air at 120 psi and a maximum pulse rate. The aerated wax resulted in an average pick-up of 38.9%, an increase of 2.8 percentage points from the non-aerated wax control. The data represented by FIG. 15B was collected using an air injector system comprising two pulsator devices pulsing air at 120 psi and maximum pulse rate, as well as at a minimum pulse rate in a subsequent trial. The aerated wax pulsed at a maximum pulse rate resulted in an average pick-up of 43.4%, an increase of 2.7 percentage points from the non-aerated wax control. The aerated wax pulsed at a minimum pulse rate resulted in an average pick-up of 39.2%, a reduction of 1.5 percentage points from the non-aerated wax control. The data represented by FIG. 15C was collected using an air injector system comprising two pulsator devices pulsing air at 120 psi and maximum pulse rate, as well as at a minimum pulse rate in a subsequent trial. The aerated wax pulsed at a maximum pulse rate resulted in an average pick-up of 43.5%, an increase of 1.8 percentage points from the non-aerated wax control. The aerated wax pulsed at a minimum pulse rate resulted in an average pick-up of 41.6%, a reduction of 0.1 percentage points from the non-aerated wax control.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the disclosure. Although specific terms are employed herein, they are used in a generic and descriptive sense only and not for purposes of limitation.

That which is claimed:

1. A method of applying an aerated meltable wax onto an object, the method comprising:
injecting air into a meltable wax such that it forms an aerated meltable wax;
delivering the aerated meltable wax through one or more meltable wax delivery conduits to a meltable wax applicator; and
contacting at least one exposed surface of the object with at least a portion of the aerated meltable wax when dispensing the aerated meltable wax from an outlet of the meltable wax applicator.

2. The method of claim 1, wherein the air is injected into the meltable wax from an air injection system comprising an air inlet, through which air flows into a first end of one or more air delivery conduits, and one or more air injector outlets coupled to a second end of the one or more air delivery conduits.

3. The method of claim 2, further comprising at least one of the steps of:
using one or more of one or more meltable wax pumps to drive the meltable wax from a meltable wax holding tank, into and through the one or more meltable wax delivery conduits, and into the meltable wax applicator through a meltable wax inlet of the applicator,
using an inline mixer positioned within one or more of the one or more meltable wax delivery conduits and downstream from the air injector system to form a wax-air solution as the meltable wax and air flow through the meltable wax delivery conduit, or
determining the amount of air present in the meltable wax at a location along the one or more meltable wax delivery conduits, the determination being conducted with a sensor positioned within one or more of the one or more meltable wax delivery conduits and downstream from the air injector.

4. The method of claim 2, wherein the one or more air injector outlets are positioned upstream from both the first and the second ends of the one or more meltable wax delivery conduits.

5. The method of claim 4, wherein the air injection system further comprises one or more air pulsing devices, the one or more air pulsing devices being located between the air inlet and the one or more air delivery conduits such that the one or more air pulsing devices may selectively pulse air from the air inlet through the one or more air delivery conduits and to the one or more air injector outlets.

6. The method of claim 4, wherein the one or more air injector outlets comprises an air nozzle, the air nozzle defining a plurality of entry openings through which air flows such that when the air nozzle is submerged in a meltable wax, the air flowing through the plurality of entry openings may create air bubbles within the meltable wax.

7. The method of claim 2, wherein the one or more air injector outlets are positioned upstream from the first end of the one or more meltable wax delivery conduits and downstream from the second end of the one or more meltable wax delivery conduits, such that the meltable wax may be aerated while flowing through the one or more meltable wax delivery conduits.

8. The method of claim 7, wherein the air injection system further comprises one or more air pulsing devices, the one or more air pulsing devices being located between the air inlet and the one or more air delivery conduits such that the one or more air pulsing devices may selectively pulse air from the air inlet through the one or more air delivery conduits and to the one or more air injector outlets.

9. The method of claim 7, wherein the one or more air injector outlets comprises an air nozzle, the air nozzle defining a plurality of entry openings through which air flows such that when the air nozzle is submerged in a meltable wax, the air flowing through the plurality of entry openings may create air bubbles within the meltable wax.

10. A meltable wax application assembly configured to apply an aerated meltable wax onto an object, the assembly comprising:
a meltable wax applicator, the meltable wax applicator comprising a meltable wax inlet and a meltable wax outlet;
one or more meltable wax delivery conduits having a first end coupled to the meltable wax inlet of the meltable wax applicator and a second end positioned proximate a meltable wax holding tank; and
an air injection system positioned upstream from the meltable wax applicator and configured to inject air into the meltable wax and generate the aerated meltable wax upstream of the inlet of the meltable wax applicator.

11. The assembly of claim 10, further comprising at least one of:
one or more of one or more meltable wax pumps, the one or more meltable wax pumps being configured to drive the meltable wax from the meltable wax holding tank, into and through the one or more meltable wax delivery conduits, and into the meltable wax applicator through the meltable wax inlet of the applicator;
an inline mixer positioned within one or more of the one or more meltable wax delivery conduits and downstream from the air injector system, the inline mixer defining a tortuous fluid travel path configured to mix the meltable wax and the air to form a wax-air solution as the meltable wax and air flow through the meltable wax delivery conduit; or
a sensor positioned within one or more of the one or more meltable wax delivery conduits and downstream from the air injector system, the sensor being configured to determine the amount of air present in the meltable wax at a location along the one or more meltable wax delivery conduits.

12. The assembly of claim 10, wherein the air injection system further comprises an air inlet, through which air flows into one or more air delivery conduits; one or more air injector outlets; and wherein: the air inlet is positioned upstream from the air injector outlet, and the one or more air injector outlets are coupled to the one or more air delivery conduits to receive air from the air inlet.

13. The assembly of claim 12, wherein the one or more air injector outlets are positioned upstream from both the first and the second ends of the one or more meltable wax delivery conduits.

14. The assembly of claim 12, wherein either:
the one or more air injector outlets are positioned within the meltable wax holding tank;
the one or more air injector outlets are positioned at least substantially proximate the second end of the one or more wax delivery conduits; or
the one or more air injector outlets are positioned upstream from the meltable wax holding tank.

15. The assembly of claim 13, wherein the air injection system further comprises one or more air pulsing devices, the one or more air pulsing devices being arranged between the air inlet and the one or more air delivery conduits such that the one or more air pulsing devices may selectively pulse air from the air inlet through the one or more air delivery conduits and to the one or more air injector outlets.

16. The assembly of claim 13, wherein the one or more air injector outlet comprises an air nozzle, the air nozzle defining a plurality of entry openings through which air flows such that when the air nozzle is submerged in a meltable wax, the air flowing through the plurality of entry openings may create air bubbles within the meltable wax.

17. The assembly of claim 12, wherein the one or more air injector outlets are positioned upstream from the first end of the one or more meltable wax delivery conduits and downstream from the second end of the one or more meltable wax delivery conduits, such that the meltable wax may be aerated while flowing through the one or more meltable wax delivery conduits.

18. The assembly of claim 17, wherein the air injection system further comprises one or more air pulsing devices, the one or more air pulsing devices being arranged between the air inlet and the one or more air delivery conduits such that the one or more air pulsing devices may selectively pulse air from the air inlet through the one or more air delivery conduits and to the one or more air injector outlets.

19. The assembly of claim 17, wherein the one or more air injector outlet comprises an air nozzle, the air nozzle defining a plurality of entry openings through which air flows such that when the air nozzle is submerged in a meltable wax, the air flowing through the plurality of entry openings may create air bubbles within the meltable wax.

20. A computer program product comprising at least one non-transitory computer-readable storage medium having computer-readable program code portions embodied therein, the computer-readable program code portions comprising one or more executable portions configured for:
controlling an injection of air into a meltable wax such that it forms an aerated meltable wax;
delivering the aerated meltable wax through one or more meltable wax delivery conduits to a meltable wax applicator; and
controlling movement of an object relative to the meltable wax applicator such that at least a portion of the aerated meltable wax dispensing from an outlet of the meltable wax applicator contacts at least one exposed surface of the object.
